(19) United States
(12) Patent Application Publication
(10) Pub. No.: US 2018/0366127 A1
(43) Pub. Date: Dec. 20, 2018

(54) SPEAKER RECOGNITION BASED ON DISCRIMINANT ANALYSIS

(71) Applicant: Intel Corporation, Santa Clara, CA (US)

(72) Inventors: Divyashree-Shivakumar Sreepathihalli, Hillsboro, OR (US); Prashant Dewan, Portland, OR (US); Uttam Sengupta, Portland, OR (US)

(21) Appl. No.: 16/007,092

(22) Filed: Jun. 13, 2018

Related U.S. Application Data
(60) Provisional application No. 62/519,414, filed on Jun. 14, 2017.

(51) Int. Cl. G10L 17/06; G10L 17/02; G10L 17/08; G10L 15/14; G10L 25/24

(52) U.S. Cl. CPC G10L 17/06; G10L 17/02; G10L 25/24; G10L 15/14; G10L 17/08

(57) ABSTRACT

A method for speaker recognition, an electronic device and a speaker recognition system are disclosed. An example method includes receiving speech data corresponding to one or more utterances from a plurality of speakers that include a plurality of voice features. A plurality of variability factors is extracted from the speech data. The dimensionality of the plurality of variability factors is reduced using a non parametric analysis, thereby generating dimensionality reduced features. A score space is defined based at least on the dimensionality reduced features.

### CROSS REFERENCE TO RELATED APPLICATIONS

The present application claims the benefit of priority from U.S. Provisional Patent Application Ser. No. 62/519,414 filed on Jun. 14, 2017 which is incorporated herein by reference in its entirety for all purposes.

### BACKGROUND

Voice is a common interaction technique to control or otherwise interact with electronic devices. Typically, speech input is processed by an electronic device in order to determine content of spoken language, such as commands that may initiate corresponding actions on the electronic device. Speech recognition is an area of computational linguistics that develops technologies enabling recognition and translation of spoken language into text that may be further processed. Electronic devices may provide speaker-independent speech recognition that recognizes spoken language without taking individual characteristics of a speaker into account. Other speech recognition systems rely on adapting or training of the system to individual speakers. Further to recognition of content in spoken language, speaker recognition systems analyze the speech input to identify speakers.

### BRIEF DESCRIPTION OF THE DRAWINGS

FIGS. 1A and 1B show flow charts of example methods according to one example of the present disclosure.

FIG. 2 illustrates an example electronic device for speaker recognition according to one example of the present disclosure.

FIG. 3 shows a schematic illustration of an example framework for speaker recognition according to one example of the present disclosure.

FIG. 4 shows an example computing device for implementing one example of the present disclosure.

### DETAILED DESCRIPTION

Speaker recognition systems typically face the problem of rapid degradation of performance when the length of speech input is decreasing. This may limit utility of speaker recognition in real world situations. Performance may be measured using an equal error rate, which reflects that the false acceptance probability is equal to the false reject probability. The equal error rate may be high for biased speech input in noisy environments. Hence, it may be difficult, if not impossible, to recognize speakers in such environments with a sufficiently high performance and reliability. Examples of the present disclosure provide speaker recognition based on discriminant analysis that is applied to reduce dimensionality of variability factors and to define a score space. This enables speaker recognition with an improved accuracy even for short utterances in noisy environments.

Examples of the present disclosure solve these problems by providing a framework for speaker recognition with an extractor, an analyzer, and a scorer, wherein the extractor extracts a plurality of variability factors based on a trained probabilistic model of voice features of a plurality of speakers. The analyzer reduces dimensionality of the plurality of variability factors using a neighborhood-based discriminant analysis in order to generate dimensionality reduced features, and defines a score space using a probabilistic discriminant analysis on the dimensionality reduced features. The scorer scores at least one variability factor of a target speaker using the score space, wherein the at least one variability factor is extracted from at least one voice feature of the target speaker using the trained probabilistic model.

Speech input may be partitioned into a plurality of utterances. In spoken language analysis an utterance may be regarded as a unit of speech. It may represent a continuous piece of speech beginning and ending with a clear pause. In speech input, an utterance may be generally, but not always bound by silence.

The variability factors are extracted from voice features of the utterances based on the trained probabilistic model. The variability factors reflect speech characteristics of individual speakers as defined by the trained probabilistic model in a highly detailed, yet selective manner. The variability factors may have a particular distribution, such as a Gaussian or unimodal distribution. However, short utterances that include speech input from noisy or biased environments, typically result in variability factors that are neither Gaussian nor unimodal. By combining a neighborhood-based discriminant analysis to reduce dimensionality of the variability factors with a probabilistic discriminant analysis to define the score space, examples of the present disclosure allow for processing of variability factors that need not to have any particular distribution. Accordingly, the underlying voice signal or utterance may include noise and channel distortions, and the score space is capable of recognizing speakers even in noisy environments based on short utterances. Furthermore, the dimensionality reduction enables an efficient processing of the flexibly distributed variability factors, saving valuable processing resources during speaker recognition.

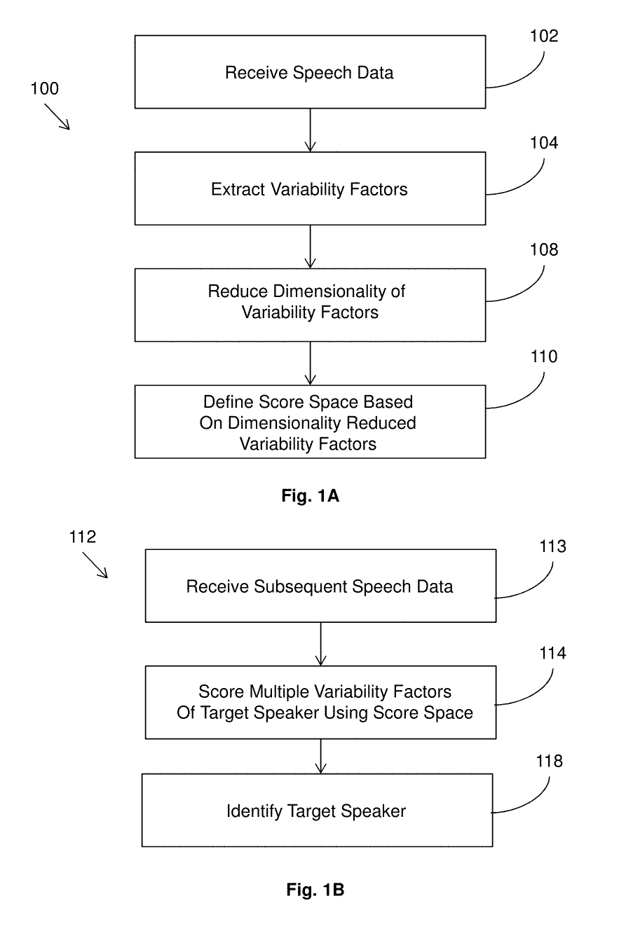

FIG. 1A illustrates a flow chart of a method 100 according to one example of the present disclosure.

The method 100 includes, at 102, receiving speech data. At 104, the method includes extracting a plurality of variability factors from the received speech data based on a trained probabilistic model of voice features of a plurality of speakers. Preferably, the trained probabilistic model may be a Universal Background Model (UBM) trained by a Gaussian Mixture Model (GMM). The UBM may be understood as a large GMM, which is trained to represent a speaker-independent distribution of features. The variability factors may be extracted using a total variability matrix trained by the UBM-GMM. It is to be understood that the UBM-GMM is one example of a probabilistic model and that another probabilistic model may be used to extract the variability factors.

According to one example, the GMM may be used to model a probability density function of a multi-dimensional feature vector. For a given speech feature vector X={xᵢ} of size F, the probability density of xᵢ given a GMM speaker model A may be defined as:

$$p ( {x}_{i} \vert λ ) = {\sum }_{c = 1}^{C} {w}_{c} g ( {x}_{i} , {μ}_{c} , {\sum }_{c} )$$

$${\sum }_{c = 1}^{C} {w}_{c} = 1$$

The UBM may be trained using training data and a speaker GMM may be established by adjusting the UBM parameters using enrollment data. A speaker utterance may be represented by the GMM as M=m+Dz. The UBM may represent all acoustic and phonetic variations in speech data where m is a supervector of size CF. D may be a diagonal matrix in full space (CF×CF) and z may be a normally distributed random vector of size CF.

The variability factors may be i-vectors. However, it is to be understood that other variability factors representing a variability of speech of various speakers may be used. The i-vectors may be determined based on the trained probabilistic model, such as the UBM-GMM using a joint factor analysis. The joint factor analysis may represent a model of speaker and session variability in GMMs and may be defined as:

M=m+Vy+Ux+Dz,

where m is a speaker-independent and session-independent supervector of size CF corresponding to the UBM and M is a speaker-dependent and session-dependent supervector. V and D define a speaker subspace and Udefines a session subspace. The vectors x, y and z are assumed to be random variables with a normal distribution. z is a normally distributed random vector of size CF. The i-vectors make no distinction between speaker effects and session-dependent factors or effects in the GMM supervector space and define a total variability space, containing speaker and session variabilities simultaneously, which is given as:

M=m+Tw,

wherein T is a low rank subspace that contains eigenvectors with the largest eigenvalues of the total variability covariance matrix.

The method 100 may proceed to 108, wherein dimensionality of the variability factors (e.g., i-vectors) is reduced using a neighborhood-based discriminant analysis, which results in dimensionality reduced features. This allows for variability factor distribution that is not required to be Gaussian or unimodal. Rather, the speech input may include noise or channel distorted signals. Preferably, a nearest neighbor rule such as a Nearest Neighbor Discriminant Analysis (NNDA) is used to post-process the variability factors. The NNDA local sample averages are computed using k nearest neighbors of each individual sample, which replace the expected values of global information for each class. The nearest neighbor rule or NNDA may maintain between-class variations and within-class variations of the variability factors.

The dimensionality reduced features are used at 110 to define a score space 112 using a probabilistic discriminant analysis. Preferably, a Probabilistic Linear Discriminant Analysis (PLDA) is used to define the score space. Even though other probabilistic discriminant analysis approaches can be used to define the score space, PLDA has advantages over other scoring techniques, such as SVM polynomial kernel or the like, and results in an optimized score space.

FIG. 1B illustrates a flow chart of a method 112 according to one example of the present disclosure.

The method 112 includes, at 113, receiving subsequent speech data from a target speaker (e.g., an utterance from a target speaker to be identified). At 114 the score space defined in method 100 is used to score multiple variability factors of the target speaker. At 118, the target speaker may be identified based on a score value as determined at 114.

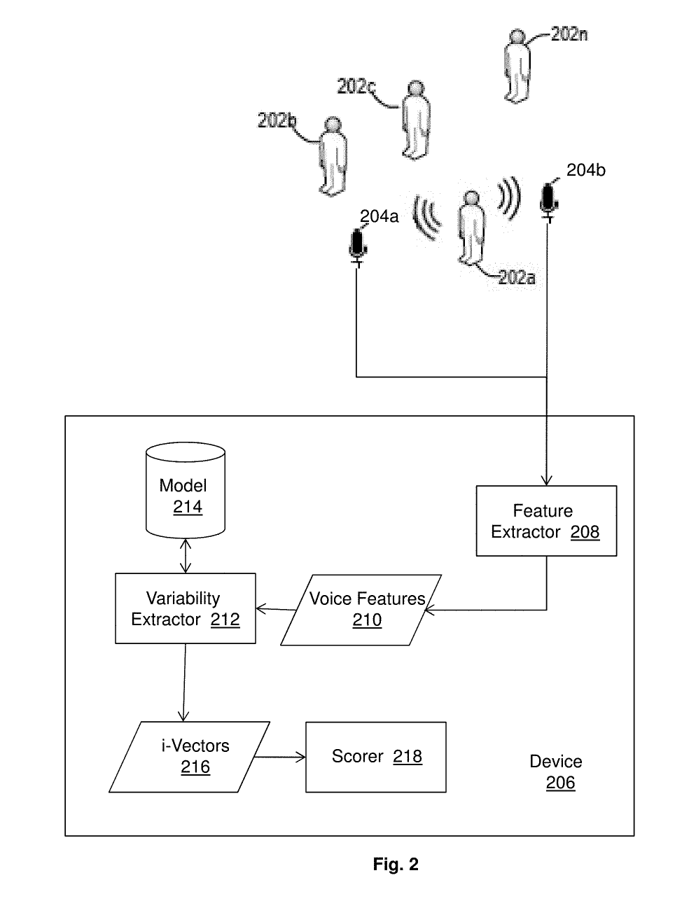

FIG. 2 illustrates an environment, wherein a speaker recognition system according to one example of the present disclosure may be implemented.

The environment 200 may be a home environment which may comprise a plurality of speakers 202a, . . . , 202n, such as friends or family members, or a business environment with a plurality of fellow workers or colleagues, wherein audio signals originating from speaker 202a and registered by microphones 204a, 204b may be intermixed with voices of the other speakers 202b, . . . , 202n. The audio signals may be far field audio signals. It is to be understood that even though a particular number of speakers or microphones is shown in FIG. 2, examples of the present disclosure are not limited by a particular number or type of recording technology. Rather, any number of speakers may be present and any number of microphones may be installed in the environment. For example, a single speaker may use a single microphone.

The microphones 204a, 204b may be connected to or may form part of a speaker recognition device 206. For example, the device 206 may be a portable device operated by speaker 202a. Likewise, the device 206 may be one or more dedicated computing devices that may be connected to the microphones 204a, 204b in the environment 200 and which may receive speech input from the microphones 204a, 204b directly or via an interconnect, bus or network in any suitable form, such as via a wired connection or link or via a wireless communication channel.

The device 206 may include a feature extractor 208 that may receive speech input from the microphones 204a, 204b, generate voice samples and extract voice features 210. For example, the feature extractor 208 may apply a Mel Frequency Cepstral Coefficients (MFCC) approach to capture phonetically important characteristics of the voice input.

The device 206 may further include a variability extractor 212 that may communicate with a trained probabilistic model 214 of voice features of a plurality of speakers. In one example, the trained probabilistic model 214 may be a UBM-GMM. The variability extractor 212 may extract a plurality of variability factors, such as i-vectors 216.

The device 206 may further include a scorer 218 that may score the i-vectors 216 using a score space. The score space may be defined by applying a probabilistic discriminant analysis, such as a PLDA, on dimensionality reduced features, wherein the dimensionality reduced features may be generated using a neighborhood-based discriminant analysis, such as an NNDA, on previously extracted variability factors. Results of the scorer 218 may include a score vector that may be used to recognize a target speaker, such as the speaker 202a.

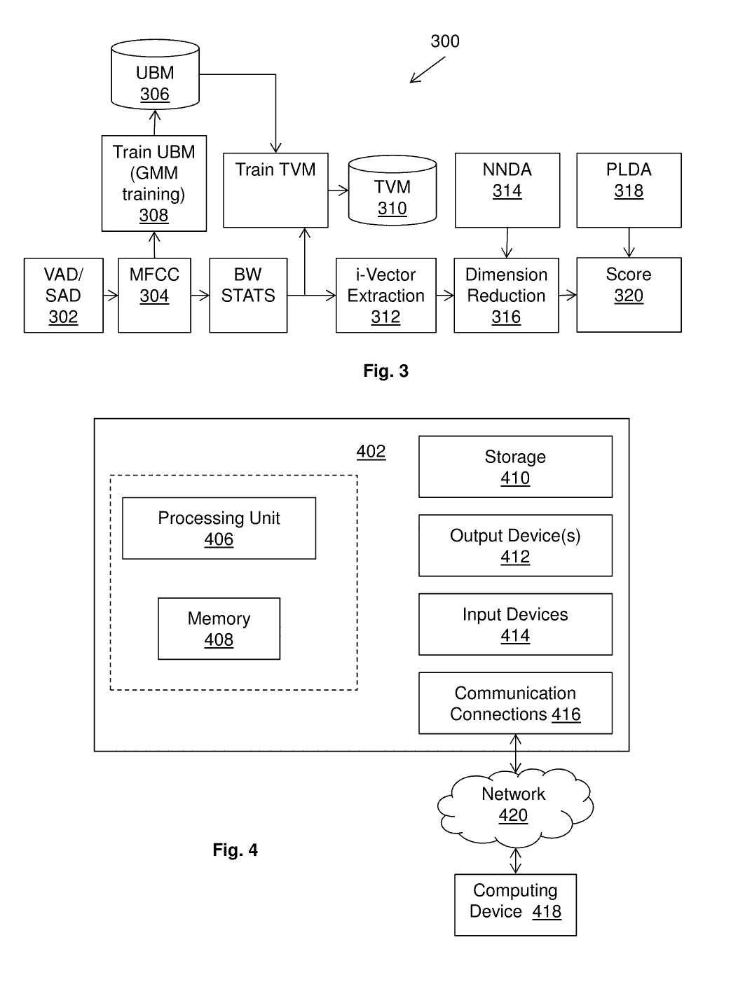

FIG. 3 illustrates a speaker recognition framework according to one example of the present disclosure. The framework 300 may be used by the methods 100, 112 of FIGS. 1A and 1B and components of the framework 300 or the framework 300 may be implemented as hardware and/or software components, in any combination, in the device 206 of FIG. 2 to recognize individual speakers.

The framework 300 may be triggered by a Voice/Speech Activity Detection (VAD/SAD) component 302. A corresponding speech input, including an acoustic or voice signal, may be pre- or post-processed, such as normalized, filtered, and the like, and features of the speech input may be extracted using MFCC 304. The extracted features may be used to train a Universal Background Model (UBM) 306 by a Gaussian Mixture Model (GMM) 308. The UBM 306 could be a large GMM which is trained to represent aspeaker-independent distribution of features.

The GMM-UBM system may be subsequently used to train a total variability matrix (TVM) 310, where it is assumed that each utterance is produced by a new speaker. In the total variability space of the TVM 310 there is no distinction between speaker and channel effects. Therefore, using the TVM 310 a plurality of variability factors may be extracted, such as i-vectors 312. Each of the i-vectors 312 controls an eigendimension of the TVM 310. Both or individually, the training of the TVM and the extraction of i-vectors 312 may be controlled by performance statistics derived from the MFCC 304 processing.

Since the distribution of i-vectors 312 is not guaranteed to be Gaussian especially in noisy environments or with channel distortions, a non-parametric, neighborhood-based discriminant analysis, such as the NNDA 314 is used to reduce the dimensionality of the i-vectors 312. This results in channel-compensated features 316 that can be modeled efficiently. In the NNDA 314, local sample averages computed using a nearest neighbor of each individual sample are used to replace an expected value that represents the global information of each class. Features 316 are subsequently used by a probabilistic linear discriminant analysis to create a score space 320 for given test and target speaker's i-vectors. For each speaker, a score vector may be computed using the score space 320, in order to identify the speaker with a reasonable accuracy.

In one example, the GMM-UBM system and the score space 320 may be used by device 206 of FIG. 2 to identify individual speakers.

The framework 300 enables speaker recognition with an expected equal error rate of 1.5 to 1.7 in noisy environments. In contrast, traditional methods based on a GMM-UBM trained speaker model achieve an equal error rate of 2.1 or higher. The improved equal error rate is achieved by a unique combination of discriminant analyses applied to process variability factors and to model the score space. Hence, the framework 300 does not require Gaussian distributed i-vectors as input. Furthermore, the framework 300 enables a speaker recognition even for short utterances between 5 and 15 seconds, preferably between 7 and 10 seconds, which is shorter than typical speech recognition systems that require utterances of at least 20 seconds and longer.

In comparison with speech recognition or language identification approaches, speaker recognition systems, such as the methods 100, 112 of FIGS. 1A and 1B, the device 206 of FIG. 2 or the framework 300 of FIG. 3, require a robust and detailed model and recognition processing. Hence, speech recognition and language identification approaches typically cannot be used for speaker recognition. For example, language identification approaches may work with short utterances, however, are completely unable to recognize individual speakers.

Examples of the present disclosure may be implemented in a variety of devices, including computing devices, mobile devices, set-top boxes, television devices, home assistance devices and any other electronic devices, such as voice-enabled electronic devices. Further examples for implementing examples include cars, home automation systems, drones, phones, and the like. FIG. 4 illustrates a corresponding example computing device 402 that is representative of one or more computing systems and/or devices that may implement the various techniques described herein. The computing device 402 may be, for example, a device operated by and/or associated with a user, or a device for speaker recognition in an environment, such as the device 206 of FIG. 2.

The computing device 402 may include a processing system 404 with at least one processing unit 406 and a memory 408. The computing device 402 may further include at least one storage 410, one or more output devices 412 and one or more input devices 414 that may establish one or more communication connections 416 to communicatively couple the computing device 402 to another computing device 418, for example, via a network 420. The computing device 402 may further include a system bus or other data and communication transfer systems (not shown) that may couple various components of the computing device 402 to each other. A system bus may include one or more of different bus structures in any combination, such as a memory bus, a peripheral bus, a local bus, a Universal Serial Bus (USB) and/or a processor bus, which may be based on a variety of bus architectures, in any combination.

The memory 408 of processing system 404 may store instructions reflecting functionality to perform one or more operations using hardware. For example, the processing system 404 may be configured to perform a method according to one or more examples of the present disclosure, in order to recognize speakers. The at least one processing unit 406 may include hardware elements that may be configured as one or more processors, cores, functional blocks, stacks and the like. This may include an implementation in hardware as a logic device formed using at least one semiconductor or integrated circuit. Hardware elements of the computing device 402 may include components of an integrated circuit or a System on Chip (SoC), an Application-Specific Integrated Circuit (ASIC), a Field-Programmable Gate Array (FPGA), a Complex Programmable Logic Device (CPLD) and other implementations in silicon or other hardware devices. In this context, a hardware element may operate as a processing device that performs program tasks or functionality as defined by instructions, modules and/or logic embodied by the various hardware elements, such as the memory 408 or the storage 410, utilized to store instructions for execution by the at least one processing unit 406. The hardware elements are not limited by certain layout or structure and may include any material from which they are formed or processing mechanisms that may be employed therein. For example, the at least one processing unit 406 may include semiconductors and/or transistors.

Various actions, such as generating, obtaining, communicating, receiving, sending, maintaining, storing, and so forth performed by various components, modules or entities are discussed herein. A particular module, component or entity discussed herein as performing an action or functionality may include that particular module, component or entity itself performing the action or alternatively that particular module, component or entity invoking or otherwise accessing another component, module or entity that performs the action or performs the action in conjunction with that particular module, component or entity as implemented in hardware elements of the processing system 404 or within the computing device 402.

The storage 410 may represent a memory or storage resource with memory or storage capacity. The storage 410 may include computer-readable media. The computer-readable media may include instructions that may reflect a method according to one or more examples of the present disclosure that, when read and executed by the processing system 404 may configure the computing device 402 to perform the method according to one or more examples of the present disclosure. The computer-readable media may enable persistent and/or non-transitory storage of information in contrast to mere signal transmission, carrier waves or signals. The computer-readable media may include hardware such as volatile and non-volatile, removable and non-removable media and/or storage modules, units or devices implemented in a method or technology suitable for storage of information, such as computer-readable instructions, data structures, program modules, logic elements, logic circuits or other data. Examples of computer-readable media include, but are not limited to, RAM, ROM, EEPROM, flash memory, CD-ROM, DVDs, Blu-Ray discs or other optical storage hard discs, magnetic cassettes, magnetic tape, magnetic disc storage or other magnetic storage devices, or other storage devices, tangible media or article of manufacture suitable to store the desired information and accessible by computing device 402. The storage 410 may include fixed media such as RAM, ROM, one or more hard drives and the like, as well as removable media, such as flash memory sticks, removable hard drives, optical discs and the like. However, it is to be understood that the computer-readable media may be configured in a variety of other ways in order to provide instructions and other data for the processing system 404 to configure the computing device 402 to perform one or more methods according to one or more examples of the present disclosure.

The computing device 402 may include I/O interfaces that may define output devices 412 and/or input devices 414 or interfaces to such input/output devices 412, 414 that may enable a user to enter commands and information to the computing device 402 and/or allow information to be presented to a user of the computing device 402. Furthermore, the I/O interfaces may define communication connections 416 to interconnect the computing device 402 with other computing devices 418 via a network 420 and/or other components of other computing devices, in any suitable way. Examples of input devices may include a keyboard, a mouse, a touch-enabled input component, a microphone, a scanner, a camera and the like. Examples of output devices may include a display device, such as a monitor or a projector, speakers, a printer, a network card, a tactile input device and the like. Furthermore, at least one input device and an output device may be combined, for example as a touch display of the computing device 402. Accordingly, the computing device 402 may be configured in a variety of ways to enable interaction of the computing device 402 with other devices or a user operating the computing device 402. Input devices 414 may further include one or more microphones to register audio or voice signals and provide speech input, which may be used by the computing device 402 to recognize a speaker according to examples of the present disclosure. In particular, the microphones may correspond to microphones 204a, 204b of FIG. 2.

Various techniques may be described herein in the general context of software, hardware elements or program modules. Generally, such modules may include routines, programs, objects, elements, components, data structures and the like that may perform particular tasks or implement particular abstract data types. The term “module”, “functionality” and “component” as used herein generally represent software, firmware, hardware or a combination thereof. The features of the techniques described herein are platform-independent, meaning that the techniques may be implemented on a variety of commercial computing platforms having a variety of processors, as provided in processing system 404. An implementation of the described modules and techniques may be stored on or transmitted across some form of computer-readable media, such as the storage 410 accessible by the computing device 402. Combinations of the foregoing may be employed to implement various techniques, methods and modules described herein. Accordingly, software, hardware or program modules may be implemented as one or more instructions and/or logic embodied on the computer-readable medium or by one or more hardware elements of the processing system 404. The computing device 402 may be configured to implement instructions and/or functions corresponding to the software and/or hardware modules according to one or more examples of the present disclosure. Accordingly, implementation of a module that is executable by the computing device 402 as a software may be achieved at least partially in hardware, such as through use of storage 410 and/or hardware elements of the processing system 404.

The computing device 402 may assume a variety of different configurations, such as for computing applications, mobile applications and in consoles or television applications. Each of these configurations may include devices that may have generally different constructs and capabilities and thus the computing device 402 may be configured according to one or more of the different application classes. The techniques described herein may be supported by various configurations of the computing device 402 and are not limited to specific examples described herein. For example, the computing device 402 may be implemented for computer applications in a device that may include a personal computer, a desktop computer, a multi-screen computer, a laptop computer, a netbook and the like. The computing device 402 may also be implemented for mobile application in a mobile device, such as a smartphone, a mobile phone, a portable music player, a portable gaming device, a tablet computer, a multi-screen computer, a home assistance device and the like. The computing device 402 may also be implemented as a console or television device that may include interactive devices connected to screens or (interactive) presentation of media. These devices may include televisions, set-top boxes, gaming consoles and the like.

The computing device 402 may be connected to any kind of network via one of the communication connections 416 or respective interfaces. For example, the communication connections 416 may include an Ethernet interface, a PLC adapter, a wireless interface for WiFi networks or a mobile network, a Bluetooth interface and the like in order to implement networking functionality as defined in one or more examples of the present disclosure. The computing device 402 may connect via the network to a server gateway or any other computing device on the network, in order to establish a connection to a target network.

It can be seen from the foregoing description that the present disclosure provides an optimized speaker recognition with an increased accuracy even in noisy environments that enable an identification of speakers based on short utterances. The recognized speakers may be automatically authenticated with a particular system. Accordingly, the recognition (or authentication) may be performed irrespective of a particular text the speaker speaks and, hence, text-independent.

Examples can include subject matter such as a method, means for performing acts or blocks of the method, at least one machine-readable medium including instructions that, when performed by a machine cause the machine to perform acts of the method or of an apparatus or system for concurrent communication using multiple communication technologies according to examples and examples described herein.

Example 1 is a method for speaker recognition, including: receiving speech data corresponding to one or more utterances from a plurality of speakers that include a plurality of voice features; extracting a plurality of variability factors from the speech data; reducing dimensionality of the plurality of variability factors using a non-parametric analysis, thereby generating dimensionality reduced features; and defining a score space based at least on the dimensionality reduced features.

Example 2 includes the subject matter of claim 1, including or omitting optional elements, wherein the variability factors include speaker-dependent factors and session-dependent factors.

Example 3 includes the subject matter of claim 1, including or omitting optional elements, further including: receiving subsequent speech data from a target speaker; scoring multiple variability factors of the target speaker using the score space; and identifying the target speaker based at least on a score of the multiple variability factors.

Example 4 includes the subject matter of claim 1, including or omitting optional elements, wherein the non-parametric analysis is a Nearest Neighbor Discriminant Analysis (NNDA).

Example 5 includes the subject matter of claim 4, including or omitting optional elements, further including using a nearest neighbor rule which maintains within-class and between-class variations of the plurality of variability factors to reduce dimensionality.

Example 6 includes the subject matter of claim 1, including or omitting optional elements, including defining the score space using a probabilistic discriminant analysis of the dimensionality reduced features.

Example 7 includes the subject matter of claim 1, including or omitting optional elements, including extracting the plurality of variability factors using a total variability matrix trained by a Universal Background Model (UBM) trained by a Gaussian Mixture Model (GMM).

Example 8 includes the subject matter of claim 7, including or omitting optional elements, wherein the total variability matrix is further trained using Baum-Welch statistics of the plurality of voice features.

Example 9 includes the subject matter of claim 1, including or omitting optional elements, wherein the plurality of voice features are determined using Mel frequency cepstral coefficients (MFCC).

Example 10 is an electronic device including and extractor and an analyzer. The extractor is configured to extract a plurality of variability factors from speech data. The analyzer is configured to reduce dimensionality of the plurality of variability factors using a non-parametric analysis, thereby generating dimensionality reduced features, and define a score space using a probabilistic discriminant analysis on the dimensionality reduced features.

Example 11 includes the subject matter of claim 10, including or omitting optional elements, further including a scorer configured to: receive, from the extractor, multiple variability factors extracted from subsequently received speech data of a target speaker; score at the multiple variability factors of the target speaker using the score space; and identify the target speaker based at least on a score of the multiple variability factors.

Example 12 includes the subject matter of claim 10, including or omitting optional elements, wherein the analyzer is configured to reduce dimensionality using a Nearest Neighbor Discriminant Analysis (NNDA).

Example 13 includes the subject matter of claim 10, including or omitting optional elements, wherein the analyzer is configured to define the score space using a probabilistic discriminant analysis of the dimensionality reduced features.

Example 14 is a computer-readable medium having computer-executable instructions stored thereon that, when executed by a computer, cause the computer to perform corresponding functions. The functions include: receiving speech data corresponding to one or more utterances from a plurality of speakers that include a plurality of voice features; extracting a plurality of variability factors from the speech data; reducing dimensionality of the plurality of variability factors using a non-parametric analysis, thereby generating dimensionality reduced features; and defining a score space based at least on the dimensionality reduced features.

Example 15 includes the subject matter of claim 14, including or omitting optional elements, wherein the instructions further include instructions that, when executed by the computer, cause the computer to perform corresponding functions, the functions including: receiving subsequent speech data from a target speaker; scoring multiple variability factors of the target speaker using the score space; and identifying the target speaker based at least on a score of the multiple variability factors.

Example 16 includes the subject matter of claim 14, including or omitting optional elements, wherein the instructions further include instructions that, when executed by the computer, cause the computer to perform corresponding functions, the functions including reducing dimensionality by computing local sample averages of a number of samples in a neighborhood of each individual sample of the plurality of variability factors.

Example 17 includes the subject matter of claim 14, including or omitting optional elements, wherein the instructions further include instructions that, when executed by the computer, cause the computer to perform corresponding functions, the functions including defining the score space using a probabilistic discriminant analysis of the dimensionality reduced features.

Example 18 includes the subject matter of claim 14, including or omitting optional elements, wherein the instructions further include instructions that, when executed by the computer, cause the computer to perform corresponding functions, the functions including extracting the plurality of variability factors using a total variability matrix trained by a Universal Background Model (UBM) trained by a Gaussian Mixture Model (GMM).

Example 19 includes the subject matter of claim 14, including or omitting optional elements, wherein the variability factors include speaker-dependent factors and session-dependent factors.

Example 20 includes the subject matter of claim 14, including or omitting optional elements, wherein the non-parametric analysis is a Nearest Neighbor Discriminant Analysis (NNDA).

In one example, the variability factors extracted from speech data are i-vectors. I-vectors represent variable-length acoustic signals in a fixed-length low-dimensional total variability subspace, see, for example, N. Dehag et al.: “Front-end factor analysis for speaker verification”, IEEE Transactions on Audio, Speech, and Language Processing, 19(4), 2011. I-vectors can be extracted from a variety of representations of voice features and model variabilities in language and channel in the same total variability subspace.

In one example, the length of the utterance is longer than 5 seconds, preferably shorter than 15 seconds, and most preferably between 7 and 10 seconds. Examples enable the use of utterances substantially shorter than 15 seconds to define the voice features. However, the utterances could have a minimum length of at least approximately 5 seconds in order to maintain a performance level and quality of the voice features processed by the neighborhood-based discriminant analysis. Hence, a preferred range of the length of utterances may be between 5 and 15 seconds, which has shown to lead to optimized results for speaker recognition. A most preferred range of utterance length may be between 7 and 10 seconds. In an initial step, the utterance length can be determined and further considered during subsequent definition of voice features and extraction of variability factors for speaker recognition. Utterances shorter than 5 seconds can be disregarded. Utterances longer than 15 seconds can be split and sub-utterances may be processed accordingly to contribute to the extraction of variability factors.

In yet another example the plurality of voice samples may be recorded by a device operated by the target speaker. This leads to voice samples with a lower distortion, wherein characteristics of the target speaker are clearly accentuated. However, examples of the present disclosure are not limited to unbiased signals and may be applicable even in noisy environment.

In one example, the plurality of voice samples is recorded as a far field audio signal of the noisy environment. Accordingly, the voice samples may include the voice of the target speaker. In far filed audio signals, the voice of the target speaker may be intermixed with voices of other people. Furthermore, attenuation of the utterance might vary significantly across distances from the speaker. Accordingly, the voice samples may be biased and distorted. This is compensated by applying the neighborhood-based discriminant analysis to reduce the dimensionality and the probabilistic discriminant analysis to model the score space in subsequent steps. The plurality of voice samples may be recorded responsive to detection of voice activity in the environment. This enables a fully automated speaker recognition, wherein a device or an environment may be set up with speaker recognition capabilities according to one or more examples of the present disclosure that may directly react on any voice activity in the environment (surrounding the device) to automatically identify the speaker.

In one example, identification of the target speaker may be based on scoring of the at least one variability factor of the target speaker. A score vector may be computed for the target speaker, which may be used as a reliability to determine whether the target speaker can be identified or not.

According to one example, the target speaker may be further authenticated with a device operated by the target speaker. Responsive to recognition of the target speaker, the target speaker may be authenticated with the device. The authentication may unlock or make available secured functionality of the device, which may be available to authenticated users only. Hence, by providing speech input to the device, the device may automatically provide secured functionality. Additionally or as an alternative, speaker recognition and authentication may be performed with regard to environments, wherein one or more recognized speakers may be authenticated with one or more registered devices associated with the environment.

In another example, the dimensionality is reduced by computing local sample averages of a number of samples in a neighborhood of each individual sample of the plurality of variability factors. The neighborhood-based discriminant analysis may be a Nearest Neighbor Discriminant Analysis (NNDA). The sample averages may be computed using k nearest neighbors (kNN) of each individual sample, which may replace an expected value representing a global information of each class. This results in dimensionality reduced features that are channel compensated and that can be modeled efficiently. Preferably, the score space is modelled based on the dimensionality reduced features using a Probabilistic Linear Discriminant Analysis (PLDA).

In one example, the trained probabilistic model is a Universal Background Model (UBM) trained by a Gaussian Mixture Model (GMM), wherein the variability factors are extracted using a total variability matrix trained by the UBM-GMM. The total variability matrix may be trained using Baum-Welch statistics of the features.

In another example, Mel Frequency Cepstral Coefficients (MFCC) are used to determine the voice features. MFCC capture phonetically important characteristics of spoken language accurately and, therefore, result in voice features of a high quality.

The method according to one or more examples can be embodied as instructions stored on computer-readable media, wherein the instructions, when executed on a computing device, cause the computing device to perform the method according to one or more examples of the present disclosure. The instructions may cause the computing device to provide a framework for speaker recognition including an extractor, an analyzer, and a scorer that may be configured to perform individual method steps. The extractor, analyzer and scorer may be provided as dedicated computing resources on one or more interconnected computing devices. In particular, the instructions may cause the computing device to extract, preferably by the extractor, a plurality of variability factors based on a trained probabilistic model of voice features of a plurality of speakers, reduce, preferably by the analyzer, dimensionality of the plurality of variability factors using a neighborhood-based discriminant analysis, thereby generating dimensionality reduced features, define, preferably by the analyzer, a score space using a probabilistic discriminant analysis on the dimensionality reduced features, and score, preferably by the scorer, at least one variability factor of a target speaker using the score space, wherein the at least one variability factor is extracted from at least one voice feature of the target speaker using the trained probabilistic model. The computing device may be configured to identify the target speaker responsive to scoring of the at least one variability factor of the target speaker.

In yet another example, an electronic device may be provided, wherein the electronic device is configured to implement a method according to one or more examples of the present disclosure. The electronic device may include at least one processor and memory, wherein the memory may include the computer-readable media according to one example of the present disclosure that may configure the electronic device to perform the method according to one or more examples of the present disclosure. The electronic device may include an extractor, an analyzer, and a scorer that may be configured to interact in order to execute the method. The extractor, analyzer and scorer may be provided as dedicated hardware, firmware, or software resources on the electronic device.

In one example, the electronic device may comprise at least one microphone configured to record a plurality of voice samples of a user. Processing of the electronic device or at least one of the extractor, analyzer, and scorer may be triggered by voice activity recorded by the at least one microphone in order to execute the method for speaker recognition according to one example of the present disclosure.

In another example, a speaker recognition system including at least one device implementing a method according to one example of the present disclosure is provided. The system may provide a framework for speaker recognition including an extractor, an analyzer, and a scorer that may be configured to perform individual method steps. The extractor, analyzer and scorer may be provided as dedicated computing resources on the at least one computing device of the system. In particular, the at least one computing device may be configured to extract, preferably by the extractor, a plurality of variability factors based on a trained probabilistic model of voice features of a plurality of speakers, reduce, preferably by the analyzer, dimensionality of the plurality of variability factors using a neighborhood-based discriminant analysis, thereby generating dimensionality reduced features, define, preferably by the analyzer, a score space using a probabilistic discriminant analysis on the dimensionality reduced features, and score, preferably by the scorer, at least one variability factor of a target speaker using the score space, wherein the at least one variability factor is extracted from at least one voice feature of the target speaker using the trained probabilistic model. The at least one computing device may be further configured to identify the target speaker responsive to scoring of the at least one variability factor of the target speaker.

While the invention has been illustrated and described with respect to one or more implementations, alterations and/or modifications may be made to the illustrated examples without departing from the spirit and scope of the appended claims. In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention.

Various illustrative logics, logical blocks, modules, and circuits described in connection with aspects disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform functions described herein. A general-purpose processor can be a microprocessor, but, in the alternative, processor can be any conventional processor, controller, microcontroller, or state machine.

The above description of illustrated examples of the subject disclosure, including what is described in the Abstract, is not intended to be exhaustive or to limit the disclosed examples to the precise forms disclosed. While specific examples and examples are described herein for illustrative purposes, various modifications are possible that are considered within the scope of such examples and examples, as those skilled in the relevant art can recognize.

In this regard, while the disclosed subject matter has been described in connection with various examples and corresponding Figures, where applicable, it is to be understood that other similar examples can be used or modifications and additions can be made to the described examples for performing the same, similar, alternative, or substitute function of the disclosed subject matter without deviating therefrom. Therefore, the disclosed subject matter should not be limited to any single example described herein, but rather should be construed in breadth and scope in accordance with the appended claims below.

In particular regard to the various functions performed by the above described components (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the disclosure. In addition, while a particular feature may have been disclosed with respect to only one of several implementations, such feature may be combined with one or more other features of the other implementations as may be desired and advantageous for any given or particular application.

1. A method for speaker recognition, comprising:
receiving speech data corresponding to one or more utterances from a plurality of speakers that include a plurality of voice features;
extracting a plurality of variability factors from the speech data;
reducing dimensionality of the plurality of variability factors using a non-parametric analysis, thereby generating dimensionality reduced features; and
defining a score space based at least on the dimensionality reduced features.

2. The method of claim 1, wherein the variability factors include speaker-dependent factors and session-dependent factors.

3. The method of claim 1, further comprising:
receiving subsequent speech data from a target speaker;
scoring multiple variability factors of the target speaker using the score space; and
identifying the target speaker based at least on a score of the multiple variability factors.

4. The method of claim 1, wherein the non-parametric analysis is a Nearest Neighbor Discriminant Analysis (NNDA).

5. The method of claim 4, further comprising using a nearest neighbor rule which maintains within-class and between-class variations of the plurality of variability factors to reduce dimensionality.

6. The method of claim 1, comprising defining the score space using a probabilistic discriminant analysis of the dimensionality reduced features.

7. The method of claim 1, comprising extracting the plurality of variability factors using a total variability matrix trained by a Universal Background Model (UBM) trained by a Gaussian Mixture Model (GMM).

8. The method of claim 7, wherein the total variability matrix is further trained using Baum-Welch statistics of the plurality of voice features.

9. The method of claim 1, wherein the plurality of voice features are determined using Mel frequency cepstral coefficients (MFCC).

10. An electronic device comprising:
an extractor configured to extract a plurality of variability factors from speech data; and
an analyzer configured to reduce dimensionality of the plurality of variability factors using a non-parametric analysis, thereby generating dimensionality reduced features, and define a score space using a probabilistic discriminant analysis on the dimensionality reduced features.

11. The electronic device of claim 10, further comprising a scorer configured to:
receive, from the extractor, multiple variability factors extracted from subsequently received speech data of a target speaker;
score at the multiple variability factors of the target speaker using the score space; and
identify the target speaker based at least on a score of the multiple variability factors.

12. The electronic device of claim 10, wherein the analyzer is configured to reduce dimensionality using a Nearest Neighbor Discriminant Analysis (NNDA).

13. The electronic device of claim 10, wherein the analyzer is configured to define the score space using a probabilistic discriminant analysis of the dimensionality reduced features.

14. A computer-readable medium having computer-executable instructions stored thereon that, when executed by a computer, cause the computer to perform corresponding functions, the functions comprising:
receiving speech data corresponding to one or more utterances from a plurality of speakers that include a plurality of voice features;
extracting a plurality of variability factors from the speech data;
reducing dimensionality of the plurality of variability factors using a non-parametric analysis, thereby generating dimensionality reduced features; and
defining a score space based at least on the dimensionality reduced features.

15. The computer-readable medium of claim 14, wherein the instructions further comprise instructions that, when executed by the computer, cause the computer to perform corresponding functions, the functions comprising:
receiving subsequent speech data from a target speaker;
scoring multiple variability factors of the target speaker using the score space; and
identifying the target speaker based at least on a score of the multiple variability factors.

16. The computer-readable medium of claim 14, wherein the instructions further comprise instructions that, when executed by the computer, cause the computer to perform corresponding functions, the functions comprising reducing dimensionality by computing local sample averages of a number of samples in a neighborhood of each individual sample of the plurality of variability factors.

17. The computer-readable medium of claim 14, wherein the instructions further comprise instructions that, when executed by the computer, cause the computer to perform corresponding functions, the functions comprising defining the score space using a probabilistic discriminant analysis of the dimensionality reduced features.

18. The computer-readable medium of claim 14, wherein the instructions further comprise instructions that, when executed by the computer, cause the computer to perform corresponding functions, the functions comprising extracting the plurality of variability factors using a total variability matrix trained by a Universal Background Model (UBM) trained by a Gaussian Mixture Model (GMM).

19. The computer-readable medium of claim 14, wherein the variability factors include speaker-dependent factors and session-dependent factors.

20. The computer-readable medium of claim 14, wherein the non-parametric analysis is a Nearest Neighbor Discriminant Analysis (NNDA).
